(19) United States
(12) Patent Application Publication
(10) Pub. No.: US 2008/0206393 A1
(43) Pub. Date: Aug. 28, 2008

(54) Mold Device for Forming

(76) Inventor: Sang-Jae Kim, Seoul (KR)

Correspondence Address: NAWROCKI, ROONEY & SIVERTSON;SUITE 401, BROADWAY PLACE EAST, 3433 BROADWAY STREET NORTHEAST, MINNEAPOLIS, MN, 554133009, US

(21) Appl. No.: 11/722,370

(22) PCT Filed: Dec. 22, 2005
(86) PCT No.: PCT/KR05/04478

§ 371 Date: Jun. 21, 2007

(30) Foreign Application Priority Data
Dec. 23, 2004 (KR) 1020040111064

(51) Int. Cl. B29C 45/34

(52) U.S. Cl. 425/546

(57) ABSTRACT

Disclosed herein is a mold device for forming a product using molten molding material. In the present invention, parting surfaces (54) and (64) of the first and second molds (50) and (60) are brought into contact with each other and, thereafter, molten molding material is injected into cavities (52) and (62). At this time, carbonized gas is continuously discharged along the parting surfaces through a continuous gas discharge circuit in a short time, without stagnating in the cavities. Preferably, the gas discharge circuit comprises a ventilation passage (70) which is formed on a first side of the parting surface (64) of the second mold (60), a gas guide groove (72) which is formed in a second side of the parting surface (64) and is parallel to the ventilation passage (70), and a plurality of gas discharge grooves (74) which are formed in the second side of the parting surface (64) and perpendicularly communicate with the gas guide groove (72).

### TECHNICAL FIELD

The present invention relates, in general, to mold devices for forming products using molten molding material and, more particularly, to a mold device for forming which is applied to an injection molding process or a diecasting process using high pressure.

### BACKGROUND ART

Generally, a mold device for forming includes two molds. The molds are filled with molten molding material at a high temperature and, thereafter, the molding material is cooled, thereby a product is formed in a desired shape. Here, the molds should prevent charged molding material from leaking outside of the molds. The molding material is hardened by cooling the molds and is prevented from leaking by the molds, thus being formed into a product.

FIG. 1 is a plan view showing a conventional mold of a mold device proposed in Korean Patent Application No. 1998-35553, which is entitled “AIR VENT STRUCTURE OF MOLD DEVICE FOR MANUFACTURING SEMICONDUCTOR PACKAGES” and has been registered. In this drawing, one mold of two molds of the mold device is shown.

As shown in the drawing, in the conventional mold 10, when high-temperature resin or molten metal is charged into a cavity 12 through a runner R at high pressure, air which has been in the cavity 12 is changed into carbonized gas by the high-temperature and high-pressure resin or molten metal. The generated carbonized gas is discharged outside of the mold through a plurality of vents 16 which are formed in respective corners of the parting surface 14. Each vent 16 is formed in a direction perpendicular to the cavity 12. Furthermore, as shown in the enlarged view, a front portion 16a and a rear portion 16b of the vent 14 are stepped.

Therefore, the conventional mold 10 allows resin or molten metal to be charged to just ahead of the front portion 16a. Furthermore, because the rear portion 16b of each vent 14 has capacity greater than that of the front portion 16a, carbonized gas is easily discharged from the cavity 12.

Meanwhile, FIG. 2 is a plan view showing a typical mold 20 which is widely used. As shown in the drawing, in this art, the mold 20 includes a plurality of vents 26, which are formed in a parting surface 24 in directions perpendicular to a cavity 22 and are spaced apart from each other at regular intervals.

Each vent 26 is configured such that the front portion 26a has a depth lower than that of the rear portion 26b, as shown in the drawing. The vents 26 perpendicularly communicate with a connection groove 27, which is formed behind the vents 26. The connection groove 27 communicates with discharge grooves 28, which are parallel to the vents 26 and are aligned with some vents 26.

Therefore, in the mold 20, high-temperature and high-pressure resin or molten metal is charged into the cavity 22 to just ahead of the front portions 26a of the vents 26. Simultaneously, carbonized gas is rapidly discharged from the cavity 22 along the parting surface 24 of the mold 20.

However, in the above-mentioned conventional mold devices, the vents 16, 26 are formed in the parting surface 14, 24 at regular intervals in directions perpendicular to the longitudinal direction of the parting surface 14, 24. Thus, there is a problem in that carbonized gas may stagnate around the vents 16, 26 while being discharged through the vents 16, 26. Furthermore, the carbonized gas may undesirably remain between the vents 16, 26 and may not be completely discharged.

Then, weld lines are formed on parts of the completed product, thereby resulting in poor surface texture. As well, such a product cannot be treated through a hardfacing process.

Furthermore, because all of the vents 16, 26 must be formed at regular intervals by machining them using a ball end mill, there is a problem in that the time required to machine the vents 16, 26 is excessively high. In addition, it is difficult to remove oxidized substances that are generated by carbonized gas and adhere to the vents 16, 26. Thus, there is a problem in that it takes an excessively long time to remove the oxidized substances.

In a detailed description of the removal of oxidized substances, a large amount of oxidized substances generally adheres to the front portions 16a, 26a of the vents 16, 26. A fiber cleaner is required to remove the adhered oxidized substances. However, because the vents 16, 26 are independently formed, every vent 16, 26 must be individually cleaned using the cleaner. Typically, this work is executed twice (in the morning and afternoon) each day.

Furthermore, it is very difficult to remove oxidized substances adhering to bent portions of the vents 16, 26. If the mold device is used without removal of the oxidized substances, incorrect flow rate of the vents 16, 26 results and, as well, the mold may be corroded by the oxidized substances adhering to the vents 16, 26. Therefore, to correct the erroneous of flow rate of the vents 16, 26 and to prevent erosion of the mold, a process of precisely grinding the vents 16, 26 must be executed, and gas flow passages of the vents 16, 26 must be ensured. Here, the grinding process is executed using a griddle or grinder.

However, because the front and rear portions 16a, 16b, 26a, 26b of the vents 16, 26 are stepped, as shown in the drawings, it is not easy to execute the precise grinding process. If the vents are damaged by carelessness during the grinding process, adjustment of error of the flow rate of the vents may be impossible. Sometimes the mold 10, 20 may have to be discarded.

Furthermore, in the conventional mold devices, the vents 16, 26 are formed at regular intervals. Thus, carbonized gas is partially stagnated around the vents 16, 26 while being discharged through the vents 16, 26 spaced apart from each other at regular intervals. Therefore, the time required to discharge the carbonized gas is increased. In particular, in the case of a high speed injection molding process, this problem affects productivity. That is, because the production of products is delayed while carbonized gas is discharged through the vents 16, 26, productivity is reduced.

The reason why the time required to discharge carbonized gas is increased is that the vents 16, 26 are partially formed, while carbonized gas is generated throughout all portions of the interior of the cavity 12, 22, as shown in the drawings. In other words, the number of vents 16, 26 is insufficient compared to the area in which carbonized gas is generated. Therefore, stagnation of carbonized gas around the vents 16, 26 is induced while it is discharged. Another reason why the time required to discharge carbonized gas is increased is that, because the vents 16, 26 are formed at regular intervals, carbonized gas must move towards the adjacent vents 16, 26 but is not discharged when it is generated. That is, the reason is that it takes some time for the carbonized gas to move to the vents 16, 26.

Moreover, in the conventional mold devices, molding material, such as resin or molten metal, is cooled while being charged into the cavity 12, 22 through the runner R. Therefore, the defective proportion is increased, and there is difficulty in manufacturing a product of high quality.

### DISCLOSURE OF INVENTION

### Technical Problem

Accordingly, the present invention has been made keeping in mind the above problems occurring in the prior art, and an object of the present invention is to provide a mold device for forming which continuously discharges carbonized gas, which is generated in a cavity of molds, along parting surfaces of the molds, unlike the conventional art, in which carbonized gas is discharged through discharge holes formed at predetermined intervals so that the carbonized gas is partially discharged outside of the molds, and in which, because carbonized gas is discharged as soon as it is generated, the carbonized gas is prevented from stagnating, and which prevents molten molding material from overflowing into the parting surfaces.

Another object of the present invention is to provide a mold device for forming which has a structure such that the cavity is heated while molding material is charged into the cavity, thus preventing the molding material from being cooled while being charged into the cavity.

### Technical Solution

In order to accomplish the above objects, the present invention provides a mold device for forming a product using molten molding material, comprising: a first mold defining therein a cavity, into which the molten molding material is injected at high pressure, and provided with a parting surface formed around the cavity; and a second mold having a cavity and a parting surface corresponding to the first mold, so that the parting surface of the second mold is brought into contact with the parting surface of the first mold and the molding material is injected into the cavities, thus forming a product, the second molding comprising: a continuous gas discharge circuit to discharge carbonized gas, generated in the cavities, outside along the parting surface, thus preventing the carbonized gas from stagnating and remaining in the cavities.

### ADVANTAGEOUS EFFECTS

In a mold device forming according to the present invention, because a ventilation passage of a gas discharge circuit is provided by a stepped portion formed on a first side of a parting surface of a mold through a single milling or electric discharge machining process, the ventilation passage can be easily machined in a short time. Furthermore, carbonized gas generated in a cavity is rapidly evenly discharged along the parting surface through the ventilation passage in a state of being uniformly dispersed. Therefore, weld lines are prevented from being formed on a product due to stagnation of the carbonized gas, and it is possible to treat the product through a hardfacing process. As such, the present invention is advantageous in that defective proportions are markedly reduced and the quality of products is increased.

Furthermore, some carbonized gas to be discharged through the ventilation passage adheres merely to the stepped portion formed on the first side of the parting surface. Accordingly, the adhered carbonized gas can be easily removed by wiping the upper surface of the stepped portion only once using a fiber cleaner. In addition, it is advantageous in that, because the upper surface of the straight stepped portion can be easily and precisely grinded using a grinding tool, inaccuracy variation of the ventilation passage is easily adjusted.

As well, carbonized gas is evenly discharged along the border of the parting surface through the ventilation passage and, simultaneously, the carbonized gas can be completely discharged by a throttling action of a gas discharge means. Hence, the amount of carbonized gas adhering to the parting surface is markedly reduced compared to the conventional arts, thus entailing an additional advantage in that the process for removing carbonized gas adhering to the parting surface is conducted less frequently. According to tests related to the frequency of processes of removing carbonized gas, only once every two or three days sufficed for removing carbonized gas, unlike the conventional arts, in which the work of removing carbonized gas must be executed twice each day.

Moreover, because carbonized gas is evenly discharged along the border of the parting surface in a state of being uniformly dispersed, the time required to discharge the carbonized gas during the injection molding is markedly reduced, thus enhancing productivity. In particular, in the case of a high speed injection molding process, the time required to form a product is reduced by 3 times or more compared to the conventional arts.

In addition, in the present invention, a heating hole heats molten molding material charged into the cavity, so that the molding material is prevented from hardening in the cavity, thus preventing defective products from arising due to hardening of the molding material.

### BRIEF DESCRIPTION OF THE DRAWINGS

FIG. 1 is a plan view showing a conventional mold;

FIG. 2 is a plan view showing a typical mold;

FIG. 3 is a perspective view of a mold of a mold device for forming, according to a first embodiment of the present invention;

FIG. 4 is a partial perspective view showing a modification of the mold of FIG. 3;

FIG. 5 is a plan view of a mold of a mold device for forming, according to a second embodiment of the present invention;

FIG. 6 is a plan view of a mold of a mold device for forming, according to a third embodiment of the present invention;

FIG. 7 is a plan view of a mold of a mold device for forming, according to a fourth embodiment of the present invention;

FIG. 8 is a perspective view of a mold of a mold device for forming, according to a fifth embodiment of the present invention; and

FIG. 9 is a plan view showing the usage of the mold of FIG. 8.

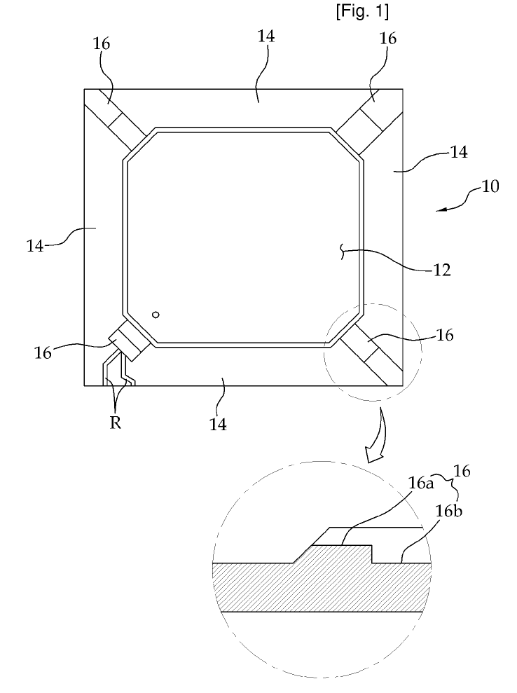

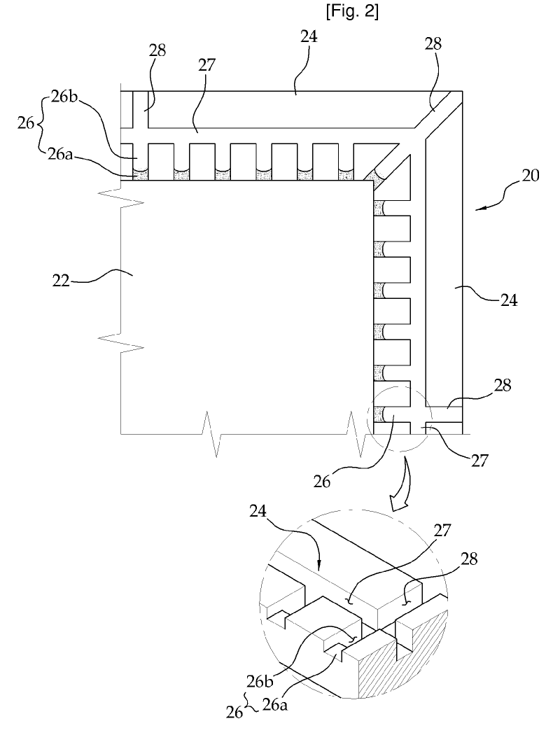

### BEST MODE FOR CARRYING OUT THE INVENTION

In the present invention, parting surfaces of first and second molds are brought into contact with each other and, thereafter, molten molding material is injected and charged into a cavity defined by the molds. At this time, air remaining in the cavity is changed into carbonized gas by the molding material injected at high pressure and high temperature. Then, the carbonized gas is continuously discharged along the parting surfaces through a continuous gas discharge circuit. Of course, because the carbonized gas is continuously discharged along the parting surfaces, it is prevented from stagnating in the cavity. Therefore, the air, having remained in the cavity, is completely discharged in a short time. As such, because the carbonized gas is completely discharged in a short time, weld lines are not formed on a product produced by the first and second molds, thus making it possible to treat the product through a hardfacing process. Here, resin, molten metal or semiconductor material, such as silicone or germanium, may be used as the molding material.

Here, the continuous gas discharge circuit of the second mold may comprise: a ventilation passage, which is defined by a stepped portion provided on a border of a first side of the parting surface of the second mold in a longitudinal direction of the parting surface, and which is defined in the longitudinal direction of the parting surface and allows only carbonized gas to be discharged from the cavity through the ventilation passage; and a gas discharge means, which is provided in a second side of the parting surface of the second mold and communicates the ventilation passage with the outside of the parting surfaces. The gas discharge means allows parts of second sides of the parting surfaces provided in the first and second molds to be brought into close contact with each other while the product is formed. Thus, while the product is formed by the first and second molds, the parting surface maintains a molding pressure applied to the interior of the cavity, and carbonized gas generated in the cavity is discharged outside the molds in a state of being evenly dispersed along the ventilation passage.

The stepped portion of the parting surface of the second mold is formed by depressing the first side of the parting surface such that the first side of the parting surface is lower than the second side of the parting surface. The ventilation passage is defined by the stepped portion having the above-mentioned configuration. That is, the ventilation passage is provided in the first side of the parting surface. In a more detailed description, the ventilation passage is formed at an upper position in the first side of the parting surface.

Because the ventilation passage extends in the longitudinal direction of the parting surface, the ventilation passage is in the direction in which molding material is charged into the cavity. Furthermore, because the ventilation passage extends in the longitudinal direction of the parting surface, carbonized gas generated in the cavity can be continuously discharged throughout the entire length of the parting surface. In other words, carbonized gas is evenly discharged outside the molds in a state of being uniformly dispersed throughout the overall parting surface.

Furthermore, the height of the ventilation passage should be determined depending on the viscosity of the molding material, such that the molding material injected into the cavity is prevented from overflowing onto the parting surface, and the width of the ventilation passage should be determined depending on the volume of the cavity. As such, if the height and width of the ventilation passage are determined by the above-mentioned method, molding material can be charged to just ahead of the ventilation passage without overflowing onto the parting surface, thus preventing burrs from forming on the product. As well, because the width of the ventilation passage is designed depending on the volume of the cavity, the ventilation passage can have a flow rate capacity corresponding to the amount of air, that is, carbonized gas that remains in the cavity. Of course, the ventilation passage has a flow rate capacity sufficient to completely discharge air remaining in the cavity.

Preferably, the height of the ventilation passage is determined within a range from 0.001 mm to 0.15 mm, and the width of the ventilation passage is determined within a range from 0.8 mm to 18.5 mm. In the case that resin is used as molding material, the height thereof preferably ranges from 0.01 mm to 0.05 mm. In detail, preferably, when nylon is used as the molding material, the height of the ventilation passage ranges from 0.01 mm to 0.02 mm, in the case of PP or PE, the height thereof ranges from 0.02 mm to 0.03 mm, in the case of HIPS, the height thereof ranges from 0.03 mm to 0.04 mm, and, in the case of ABS, the height thereof ranges from 0.01 mm to 0.045 mm. Furthermore, in the case that the viscosity of the molding material is very low, that is, the molding material is very thin, the height of the ventilation preferably ranges from 0.001 mm to 0.099 mm. In addition, when molten metal is used as molding material, the height thereof is preferably 0.05 mm or more.

Meanwhile, when resin is used as molding material, the width of the ventilation passage preferably ranges from 2 mm to 15 mm. When molten metal is used as molding material, the width thereof is preferably greater than 15 mm. As mentioned above, the height and width of the ventilation passage should be adjusted depending on the molding material and volume of the cavity. Particularly, in the case that the mold device is used for manufacturing semiconductors, it must be specially designed to correspond to the design characteristics according to type of semiconductor. Therefore, in this case, the height and width of the ventilation passage may have values different from the above-stated values.

The ventilation passage having the above-mentioned configuration is continuous along the parting surface, so that the outline of the ventilation passage has an open loop or closed loop shape. Here, the outline of the ventilation passage is determined depending on the shape of the runner formed in the first and second molds. In detail, if the runner crosses the parting surface in a direction perpendicular to the longitudinal direction of the parting surface, the ventilation passage has a closed loop shape. That is, the ventilation passage is not formed at the position at which the runner is disposed, but the ventilation passage is merely formed around portions of the parting surface, other than the position at which the runner is disposed. Of course, the outline of the ventilation passage may be determined to have an open or closed loop shape due to factors other than the runner. A partitioning wall, which will be explained later herein, is an example of such a factor.

Meanwhile, the prevent invention may further include at least one partition wall which protrudes on the first side of the parting surface having the stepped portion, thus partitioning the ventilation passage.

It is preferable that the partition wall be formed along with the parting surface during a process of forming the mold. However, the partition wall may be separately provided and be welded to the parting surface. The set position of the partition wall is determined depending on the position of an outlet of the runner, through which molding material is injected into the cavity. Furthermore, the length and height of the partition wall are determined depending on the pressure of molding material when discharged from the runner. If the outlet of the runner crosses the ventilation passage, the partition wall is provided at the position at which the outlet crosses the ventilation passages, such that the outlet of the runner is formed through the partition wall. Furthermore, in the case that molding material is discharged from the runner at very high pressure, a partition wall is provided on the first side of the parting surface which is placed opposite the outlet of the runner, thus preventing the molding material discharged from the runner from overflowing onto the parting surface. Here, if molding material is discharged at ultra high pressure, the partition wall is preferably relatively high and long. If molding material is discharged at relatively low pressure, the partition wall may be relatively low and short.

Meanwhile, the gas discharge means may comprise: a gas guide groove, which is formed in the second side of the parting surface and is connected directly with the ventilation passage in a direction parallel to the ventilation passage such that the gas guide groove extends in a longitudinal direction of the ventilation passage, and which has a flow rate capacity equal to or greater than the flow rate capacity of the ventilation passage; and a plurality of gas discharge grooves, which are formed in the second side of the parting surface and communicate both with the gas guide groove, in directions different from that of the gas guide groove, and with the outside of the parting surface. The gas discharge grooves have a flow rate capacity equal to or greater than the flow rate capacity of the ventilation passage. Therefore, the gas discharge means is constructed such that the parting surface, which has at the second side thereof an uneven surface formed by the gas discharge grooves, serve to guide, throttle and discharge the carbonized gas drawn into the ventilation passage while maintaining the molding pressure of the cavity.

Here, the ventilation passage is a space provided on the first side of the parting surface having the stepped portion, and the gas guide groove and gas discharge grooves have slot shapes which are formed in the second side of the parting surface and have predetermined lengths. It is preferable that each of the ventilation passage and the gas guide groove be longer than each gas discharge groove. Furthermore, preferably, each gas discharge groove is perpendicular to or angled from the gas guide groove outwards and sideways.

Alternatively, the gas discharge means may comprise: a plurality of gas discharge grooves which are formed in the second side of the parting surface at regular intervals and communicate both with the ventilation passage, in directions different from the ventilation passage, and with the outside of the parting surface. The gas discharge grooves have a flow rate capacity equal to or greater than the flow rate capacity of the ventilation passage. Therefore, the gas discharge means is constructed such that the parting surface has at the second side thereof an uneven surface formed by the gas discharge grooves, thereby the parting surface guides discharge of the carbonized gas drawn into the ventilation passage while maintaining the molding pressure of the cavity.

It is preferable that the ventilation passage have a length that is greater than that of each gas discharge groove. In other words, each gas discharge groove is shorter than the ventilation passage.

As a further alternative, the gas discharge circuit may comprise: a gas collection groove, which is formed in the second side of the parting surface and is spaced apart from the ventilation passage by a predetermined distance such that the gas collection groove is parallel to the ventilation passage, and which has a flow rate capacity equal to or greater than the flow rate capacity of the ventilation passage; a plurality of bridge grooves which are formed in the second side of the parting surface and are connected both to the gas collection groove and to the ventilation groove in different directions from the gas collection groove and the ventilation groove, and which are spaced apart from each other at regular intervals and have a flow rate capacity equal to or greater than the flow rate capacity of the ventilation passage; and a plurality of gas discharge grooves which are formed in the second side of the parting surface at regular intervals and communicate both with the gas collection groove, in directions different from that of the gas collection groove, and with the outside of the parting surface, and which have a flow rate capacity equal to or greater than the flow rate capacity of the ventilation passage. Therefore, the parting surface has at the second side thereof an uneven surface formed by the gas collection groove, the bridge grooves and the gas discharge grooves, thereby the parting surface guides and throttles the carbonized gas drawn into the ventilation passage, such that the carbonized gas is discharged outside of the parting surface, while maintaining the molding pressure of the cavity.

Here, the gas discharge grooves may be formed by extending bridge grooves. Furthermore, the number of gas discharge grooves may be equal to the number of bridge grooves, and each gas discharge groove may be aligned with a bridge groove. It is preferable that each gas discharge groove be shorter than the ventilation passage and the gas collection groove, and a connection groove be shorter than the gas discharge groove.

Here, each of the gas guide grooves, the gas discharge grooves, the gas collection groove and the bridge grooves has a slot shape and may be straight or, alternatively, may be curved with a predetermined curvature. Furthermore, it may have a circular, semi-circular, rectangular or triangular cross-section. It may have various cross-sections other than the shapes given. That is, in the present invention, it is not limited to the cross-sections given above.

As well, each of the gas discharge grooves and the bridge grooves may be perpendicular to the vent passage, the gas guide groove or the gas collection groove or, alternatively, may be angled in a sideways direction with respect to the vent passage, the gas guide groove or the gas collection groove.

Meanwhile, the present invention may further comprise a hardening prevention means which heats the high-temperature molding material injected into the cavity, so that the molding material is prevented from hardening while being charged into the cavity.

The hardening prevention means may comprise a heating hole, which is formed in at least one of the first mold and the second mold along the cavity, so that heating fluid at a high temperature circulates the heating hole, thereby the molding material injected into the cavity maintains a molten state using radiant heat of the heating fluid.

Here, the heating hole may have a straight, zigzag or spiral shape or a curved shape having a predetermined curvature. Furthermore, the heating hole may have a circular, semi-circular, rectangular or triangular cross-section. However, for ease of machining the heating hole, it preferably has a straight shape with a circular cross-section.

Meanwhile, high-temperature water may be used as heating fluid, which circulates in the heating hole. It is preferable that high-temperature steam be used as the heating fluid. Of course, a mixture of high-temperature water and steam may be used as heating fluid or, alternatively, water and steam may be alternately used.

The diameter, number and shape of heating holes are determined by the thickness of the first mold or the second mold or the capacity or width of the cavity. That is, the heating hole may have a relatively large diameter depending on the thickness of the first or second mold or, alternatively, may have a small or fine diameter. Furthermore, a single heating hole may be provided or, alternatively, a plurality of heating holes may be provided. As well, the heating hole may have a straight, curved or zigzag shape.

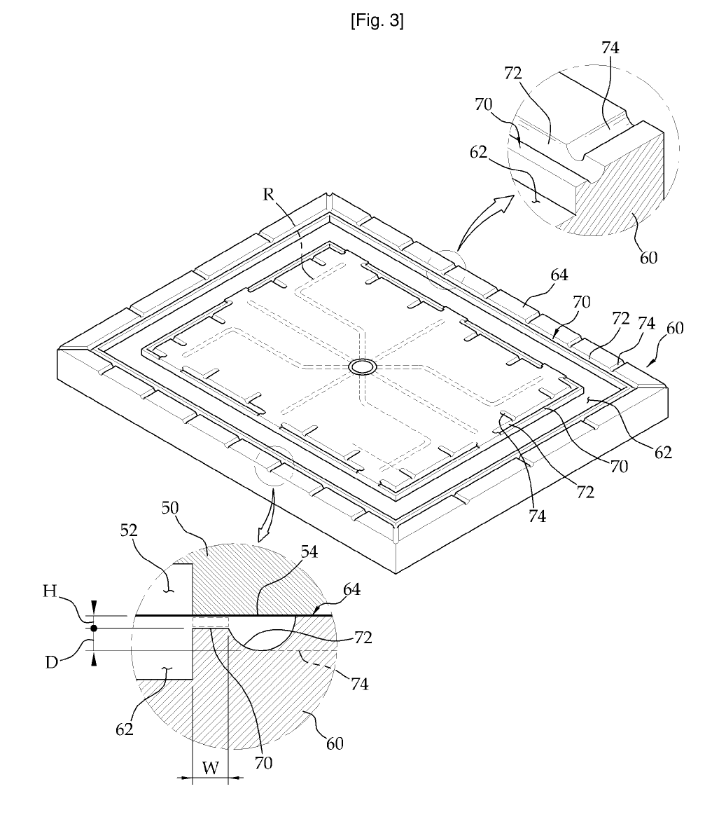

Hereinafter, a mold device for forming according to the present invention will be described in detail with reference to the attached drawings. FIG. 3 is a perspective view of a mold of a mold device for forming, according to a first embodiment of the present invention. The mold device for forming according to the first embodiment of the present invention includes a first mold 50 and a second mold 60, which is brought into close contact with the first mold 50 to form a product along with the first mold 50, as shown in the enlarged view of FIG. 3.

As shown in the drawing, the first and second molds 50 and 60 respectively have therein cavities 52 and 62, which correspond to each other, and parting surfaces 54 and 64, which are respectively provided around inner and outer borders of the cavities 52 and 62. The parting surfaces 54 and 64 are brought into close contact with each other, so that molten molding material (for example, resin or molten metal) of a high temperature is charged into the cavities 52 and 62 through a runner R at high pressure.

In other words, the first and second molds 50 and 60 are brought into close contact with each other. The cavities 52 and 62 serve to form the charged molding material into a product. Here, the molding material, which has been charged into the cavities 52 and 62, is cooled and hardened, thus being changed into a product.

Meanwhile, a continuous gas discharge circuit is defined in the parting surface 64 of the second mold 60, such that residual air, that is, carbonized gas, is discharged through the continuous gas discharge circuit. The present invention is characterized by the continuous gas discharge circuit. The continuous gas discharge circuit includes a ventilation passage 70, which is shown in the enlarged view disposed at a lower position in the drawing, and a gas discharge means.

The ventilation passage 70 is a space which is defined on the parting surface 64 in the longitudinal direction of the parting surface 64 by a stepped portion formed by depressing an edge of a first side of the parting surface 64 along a longitudinal direction of the parting surface 64. In other words, the ventilation passage 70 is defined by the stepped portion of the parting surface 64. At this time, the stepped portion is formed along the parting surface 64 in a straight line.

The above-mentioned stepped portion is formed by machining the first side of the parting surface 64 through a milling or electric discharge machining process. The stepped portion is formed throughout the entire first side of the parting surface 64. As such, the milling or electric discharge machining is used for machining the stepped portion, because the milling process and the electric discharge machining process make it possible for the stepped portion to be formed through a single process. The ventilation passage 70 is defined by the stepped portion in a straight line along the parting surface 64. Therefore, carbonized gas that remains in the cavities 52 and 62 is dispersed along the ventilation passage 70 throughout the parting surface 64 and, thus, is evenly discharged in a state of being uniformly dispersed along a longitudinal direction of the parting surface 64. Thereby, the carbonized gas that remains in the cavities 52 and 62 can be smoothly discharged without stagnating in the cavities 52 and 62.

Furthermore, the ventilation passage 70 is configured such that only carbonized gas is discharged from the cavities 52 and 62. As such, in order to accomplish a structure of the ventilation passage 70 such that only carbonized gas is discharged, the ventilation passage 70 must be specially designed with respect to height H and width W. In a detailed description, the height H of the ventilation passage 70 preferably ranges from 0.001 mm to 0.15 mm depending on the viscosity of the molding material, such that the molding material, which is injected into the cavities 52 and 62, is prevented from overflowing into the parting surface 64. Furthermore, the width W of the ventilation passage 70 preferably ranges from 0.8 mm to 18.5 mm depending on the volume of the cavities 52 and 62.

In this embodiment, the ventilation passage 70 is designed to have a height H of 0.02 mm in consideration of the viscosity of PP or PE and is designed to have a width W of 8 mm. Of course, PP and PE are merely examples of molding material used in this embodiment. As such, the ventilation passage 70 prevents the molding material from overflowing and allows only carbonized gas to be discharged.

Furthermore, as shown in the drawing, the ventilation passage 70 is continuous along the parting surface 64. Therefore, the outline of the ventilation passage 70 has an open loop or closed loop shape. That is, the ventilation passage 70 may be formed in a continuous shape on the parting surface 64. Alternatively, the ventilation passage 70 may be formed to have a shape which is blocked at a predetermined position. In other words, the ventilation passage 70 may be discontinuous on the parting surface 64 by blocking it at a predetermined position on the parting surface 64.

Meanwhile, the gas discharge means is provided on a second side of the parting surface 64 and communicates the ventilation passage 70 with the outside of the first and second molds 50 and 60. Furthermore, the gas discharge means is configured such that parts of the second sides of the parting surfaces 54 and 64 of the first and second molds 50 and 60 are brought into close contact with each other when forming a product.

As shown in the enlarged view, the gas discharge means includes a gas guide groove 72 and a plurality of gas discharge grooves 74 which are formed in the second side of the parting surface 64. As shown in the drawing, the gas guide groove 72 communicates with the ventilation passage 70 such that they are parallel to each other. That is, the gas guide groove 72 extends in the same direction as the longitudinal direction of the ventilation passage 70. The gas discharge grooves 74 perpendicularly communicate with the gas guide groove 72 and extend to the outside of the parting surface 64. Therefore, each gas discharge groove 74 extends from the gas guide groove 72 to the opposite side of the parting surface 64, so that it is not parallel to the gas guide groove 72.

The gas guide groove 72 and the gas discharge grooves 74 are configured such that they have a flow rate capacity equal to or greater than that of the ventilation passage 70. It is preferable that they be configured such that the flow rate capacity thereof is greater than that of the ventilation passage 70. The flow rate capacity thereof is determined by the depth D of the gas guide groove 72 or each gas discharge groove 74, as shown in the enlarged view disposed at the lower position of the drawing. Therefore, in the present invention, carbonized gas, having passed through the ventilation passage 70, can be smoothly discharged outside of the parting surface 64 through the gas guide groove 72 and the gas discharge grooves 74.

As such, the parting surface 64 has at the second side thereof an uneven surface defined by the gas discharge grooves 74. The parting surface 64 of the second mold 60 guides carbonized gas, having passed through the ventilation passage 70, such that the gas is discharged outside by throttling. Furthermore, as shown in the enlarged view (the sectional view), the parting surface 64 is in close contact with the parting surface 54 of the first mold 50, such that the pressure in the cavities 52 and 62 is maintained. At this time, in the present invention, the carbonized gas is discharged still more smoothly by the throttling action in the gas guide groove 72 and the gas discharge grooves 74.

In conclusion, in the mold device for forming according to the first embodiment of the present invention, when a product is formed using the first and second molds 50 and 60, carbonized gas generated in the cavities 52 and 62 is evenly discharged in a state of being uniformly distributed along the ventilation passage 70, while the parting surface 64 maintains a molding pressure in the cavities 52 and 62.

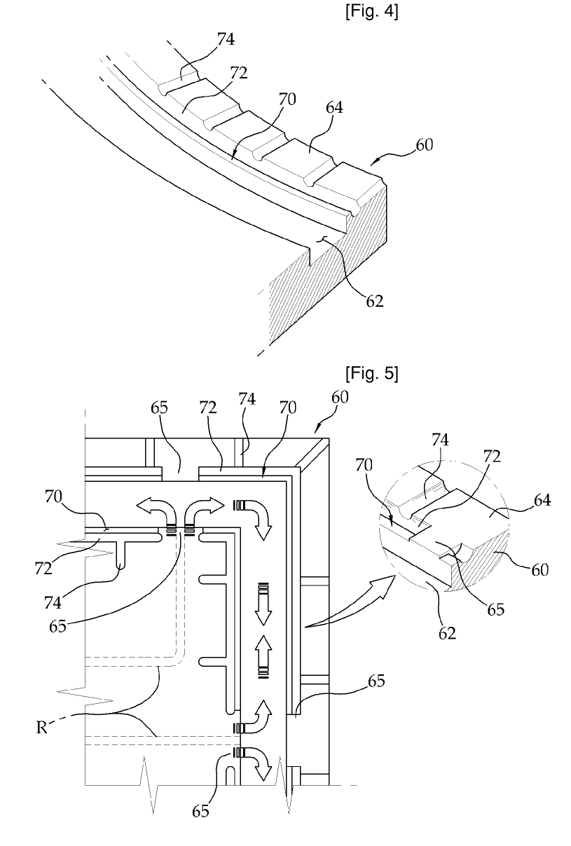

FIG. 4 is a partial perspective view showing a modification of the mold shown in FIG. 3, showing an example in which the continuous gas discharge circuit of the first embodiment is applied to a mold 60 having a rounded parting surface 64. The mold 60 of FIG. 4 has the same structure and operation as those of the mold described above, therefore the explanation of the first embodiment serves to explain the structure and operation of the mold 60. Thus, further explanation is deemed unnecessary.

FIG. 5 is a plan view of a mold of a mold device for forming, according to a second embodiment of the present invention. The general construction of the second embodiment is the same as that of the first embodiment. However, unlike the first embodiment, the second embodiment includes a plurality of partition walls 65, each of which protrudes and extends from the side of the parting surface 64 having a stepped portion.

The partition walls 65, each of which extends from the side of the parting surface 64 as shown in an enlarged view, are preferably formed along with the second mold 60 through a single forming process.

Here, as shown in the drawing, the partition walls 65 may be provided on a side of the parting surface 64, at which outlets of a runner R are positioned. Alternatively, the partition walls 65 may be provided on a side of the parting surface 64, which is at a position opposite the outlets of the runner R. As a further alternative, the partition walls 65 may be provided both at the side at which the outlets of the runner R are positioned and at the side opposite the outlets of the runner R. As such, in this embodiment, a ventilation passage 70 is divided into several sections by the partition walls 65.

In the case that the partition walls 65 are provided at the side at which the outlets of the runner R are positioned, the runner R passes through the partition walls 65. Therefore, each outlet of the runner R is formed at a lower position in each partition wall 65. The formation of partition walls 65 at the outlet side of the runner R is advantageous in that the outlets of the runner R extend such that molding material is directly charged into the cavity 62.

In the case that the partition walls 65 are provided opposite the outlets of the runner R, the partition walls 65 are disposed at positions higher than the outlets of the runner R. As such, the reason why the partition walls 65 are provided opposite the outlets of the runner R is that molding material may be injected through the runner R at ultra high pressure. For example, molding material is injected at ultra high pressure at the moment the injection of the molding material into the cavity 62 begins and when the injection of the molding material into the cavity 62 is almost finished. Here, in the case that the molding material is injected at ultra high pressure when the injection of the molding material is almost finished, the cavity 62 can be compactly filled with molding material.

At this time, the partition walls 65 serve to prevent molding material injected at ultra high pressure from overflowing onto the parting surface 64 due to high injection pressure. In a detailed description, molding material injected at ultra high pressure tends to overflow onto the parting surface 64 due to high injection pressure. However, thanks to the partition walls 65, the molding material flows in directions designated by the arrows of the drawing and is charged into the cavity 62 without overflowing onto the parting surface 64.

Meanwhile, the partition walls 65 may be formed at positions other than the positions corresponding to the runner R. For example, the partition wall 65 may be formed on the first side of the parting surface 64 at a position at which pressure in the cavity 62 is lower than that of other positions. As such, if the partition wall 65 is formed at a position at which pressure in the cavity 62 is lower, the partition wall 65 can prevent loss of pressure in the cavity 62.

The partition wall 65 having the above-mentioned function may have a relatively long length, as shown in the drawing. Alternatively, the partition wall 65 may have a short length. Furthermore, the partition wall 65 may be formed at the same height as that of the second side of the parting surface 64 or, alternatively, it may be formed at a height lower than the height of the second side of the parting surface 64. Here, the length and height of the partition wall 65 are determined depending on the pressure in the runner R, the pressure in the molding material discharged from the runner R, or the pressure in the cavity 62. It is preferable that the height of the partition wall 65 be the same as that of the second side of the parting surface 64, as shown in the drawing. As such, in the case that the partition wall 65 is formed at the same height as that of the second side of the parting surface 64, the upper surface of the partition wall 65 can be brought into close contact with the parting surface 52 of the first mold 50, thus maintaining molding pressure in the cavities along with the parting surfaces 52 and 62.

The partition wall 65 having the above-mentioned functions may be applied to the following third through fifth embodiments.

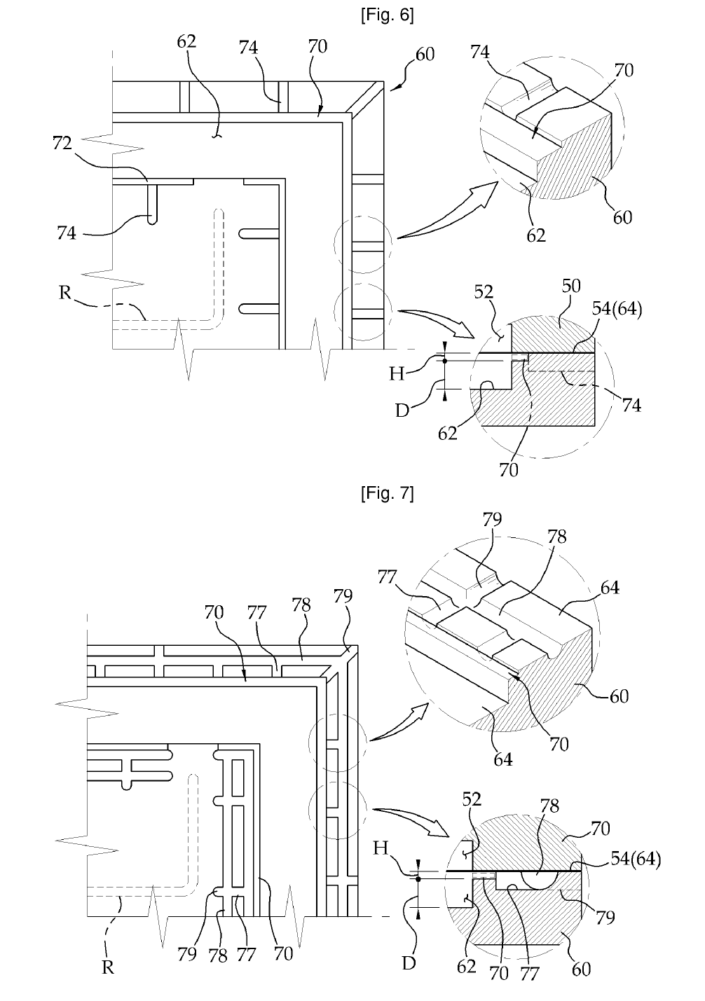

FIG. 6 is a plan view of a mold of a mold device for forming, according to a third embodiment of the present invention. The general construction of the third embodiment, other than the gas discharge means, is the same as that of the first embodiment.

The gas discharge means according to the third embodiment of the present invention comprises a plurality of gas discharge grooves 74, each of which communicates both with a ventilation passage 70 in a direction different from the longitudinal direction of the ventilation passage 70 and with the outside, and which has a flow rate capacity equal to or greater than that of the ventilation passage 70. The flow rate capacity of each gas discharge groove 74 is determined by the depth D of the gas discharge groove 74, as shown in the enlarged view (the sectional view) disposed at the lower position of the drawing.

As shown in the drawing, the gas discharge grooves 74 are formed in a second side of a parting surface 64 and are spaced apart from each other at regular intervals.

Furthermore, each gas discharge groove 74 perpendicularly communicates with the ventilation passage 70. That is, each gas discharge groove 74 is formed in a direction different from the longitudinal direction of the ventilation passage 70.

As such, the third embodiment has the construction in which only the gas discharge grooves 74 are formed in the second side of the parting surface 64 without the gas guide groove 72, unlike the first embodiment.

Furthermore, the gas discharge grooves 74 form an uneven surface on the second side of the parting surface 64. Therefore, while the parting surface 64 of a second mold 60 is brought into close contact with a parting surface 54 of a first mold 50, molding pressure in cavities 52 and 62 is maintained and carbonized gas is guided through the ventilation passage 70 and is discharged outside of the mold device through the gas discharge grooves.

FIG. 7 is a plan view of a mold of a mold device for forming, according to a fourth embodiment of the present invention. The general construction of the fourth embodiment, other than the gas discharge means, is the same as that of the first embodiment.

As shown in the drawing, the gas discharge means according to the fourth embodiment includes a plurality of bridge grooves 77, a gas collection groove 78, and a plurality of gas discharge grooves 79. The gas collection groove 78 is parallel with and spaced apart from a ventilation passage 70 by a predetermined distance. The bridge grooves 77 are perpendicularly connected both to the gas collection groove 78 and to the ventilation passage 70, and are spaced apart from each other at regular intervals. The gas discharge grooves 79 are perpendicularly connected to the gas collection groove 78 and are configured such that they are spaced apart from each other at regular intervals and communicate with the outside of the parting surface 64.

Of course, the gas discharge grooves 79 are formed in a second side of a parting surface 64. In other words, the gas discharge grooves 79 extend from the gas collection groove 78 to the second side end of the parting surface 64. Furthermore, as shown in the drawing, the bridge grooves 77, the gas collection groove 78 and the gas discharge grooves 79 are continuously formed in the second side of the parting surface 64. As well, each bridge groove 77 and each gas discharge groove 79 are perpendicular both to the ventilation passage 70 and to the gas collection groove 78, that is, they are formed in directions different from that of the ventilation passage 70 and the gas collection groove 78.

Here, the bridge grooves 77, the gas collection groove 78 and the gas discharge grooves 79 have flow rate capacities equal to or greater than that of the ventilation passage 70. It is preferable that they have flow rate capacities greater than that of the ventilation passage 70. The flow rate capacities of each bridge groove 77 and the gas collection groove 78 are determined by depths D of the bridge groove 77 and the gas collection groove 78, as shown in the enlarged view (the sectional view) at the bottom of the drawing. Because the flow rate capacities of each bridge groove 77 and the gas collection groove 78 are greater than that of the ventilation passage 70, carbonized gas is guided from the ventilation passage 70 and smoothly discharged while being throttled.

Furthermore, as shown in the drawing, it is preferred that the number of gas discharge grooves 79 be lower than that of the bridge grooves 77. Of course, the number of gas discharge grooves 79 should be determined in consideration of the flow rate capacity of the ventilation passage 70.

The gas collection groove 78, the bridge grooves 77 and the gas discharge grooves 79 form an uneven surface on the second side of the parting surface 64. Therefore, the parting surface 64 maintains a molding pressure in cavities 52 and 62 while forming a product, and guides and throttles carbonized gas, having entered the ventilation passage 70, and discharges the gas outside of the mold device.

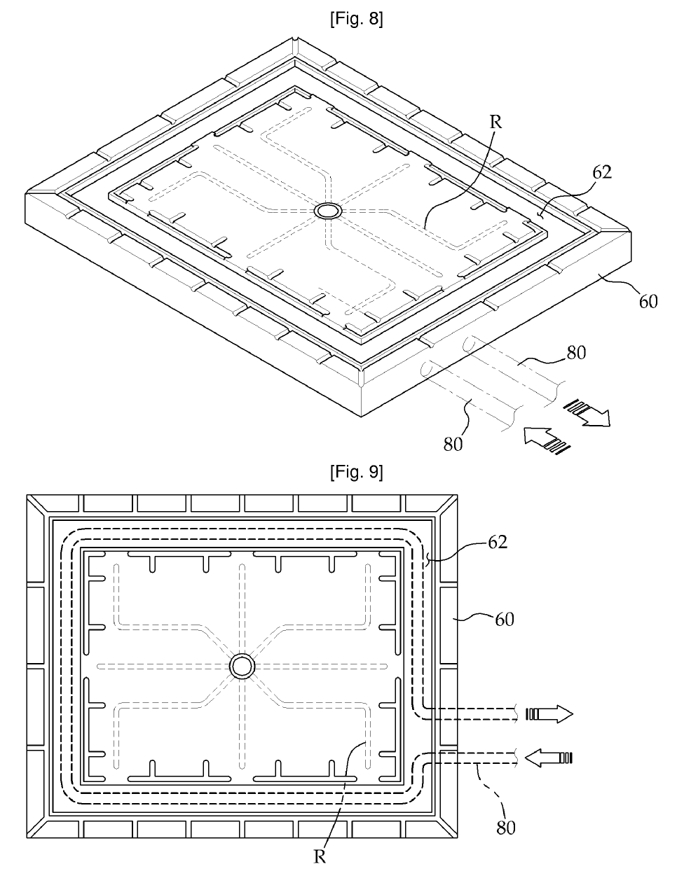

FIG. 8 is a plan view of a mold of a mold device for forming, according to a fifth embodiment of the present invention. FIG. 9 is a plan view showing the usage of the mold of FIG. 8. The mold device according to the fifth embodiment includes a hardening prevention means which heats molding material, which is injected into cavities 52 and 62, at high temperature, thus preventing the molding material from hardening while being charged into the cavities 52 and 62.

The hardening prevention means comprises a heating hole 80, along which heating fluid at a high temperature circulates, as shown in the drawing. Here, the heating hole 80 is formed in at least one of first and second molds 50 and 60. High-temperature steam is used as the heating fluid. Furthermore, as shown in the drawing, the heating hole 80 has an inlet and outlet, through which heating fluid, that is, high-temperature steam, is supplied and discharged.

The heating hole 80 is formed along the cavities 52 and 62, as shown in the drawing. The diameter and number of heating holes 80 are determined by the thickness of the first or second mold 50 or 60 and the capacity or width of the cavities 52 and 62. Of course, the heating hole 80 must not communicate with the cavities 52 and 62, so that steam circulates in the heating hole 80 without loss.

When high-temperature steam circulates in the heating hole 80, the surroundings of the cavities 52 and 62 are heated, so that molding material injected into the cavities 52 and 62 can maintains a molten state using radiant heat of the heating fluid.

Although the preferred embodiment of the present invention has been disclosed for illustrative purposes, the present invention is not limited to the preferred embodiment, and various modifications are possible, without departing from the scope and spirit of the invention. Therefore, those skilled in the art will appreciate that the shape and structure of each element explained in the embodiments of the present invention may be changed, and these modifications fall within the bounds of the present invention.

### INDUSTRIAL APPLICABILITY

As described above, the present invention provides a mold device for forming which continuously discharges carbonized gas, which is generated in a mold cavity, along parting surfaces of the molds, unlike the conventional art, in which carbonized gas is discharged through discharge holes formed at predetermined intervals so that the carbonized gas is partially discharged outside of the molds. Furthermore, because carbonized gas is discharged as soon as it is generated, the carbonized gas is prevented from stagnating. As well, in the present invention, molten molding material is prevented from overflowing into the parting surfaces.

1. A mold device for forming a product using molten molding material, comprising:
a first mold defining therein a cavity, into which the molten molding material is injected at high pressure, and provided with a parting surface formed around the cavity; and
a second mold having a cavity and a parting surface corresponding to the first mold, so that the parting surface of the second mold is brought into contact with the parting surface of the first mold and the molding material is injected into the cavities and, thus forming a product, the second molding comprising:
a continuous gas discharge circuit to discharge carbonized gas, generated in the cavities and, outside along the parting surface, thus preventing the carbonized gas from stagnating and remaining in the cavities.

2. The mold device for forming according to claim 1, wherein the continuous gas discharge circuit of the second mold comprises:
a ventilation passage defined by a stepped portion provided on a first side of the parting surface in a longitudinal direction of the parting surface, the ventilation passage being defined in a direction equal to the longitudinal direction of the parting surface and allowing only carbonized gas to be discharged from the cavities and through the ventilation passage; and gas discharge means provided in a second side of the parting surface and communicating the ventilation passage with the outside of the parting surfaces and, the gas discharge means allowing second sides of the parting surfaces and provided in the first and second molds and to be partially brought into close contact with each other when the product is formed, so that, while the product is formed by the first and second molds, the parting surface maintains a molding pressure applied to an interior of the cavities, and the carbonized gas generated in the cavities is discharged in a state of being evenly dispersed along the ventilation passage.

3. The mold device for forming according to claim 2, wherein a height (H) of the ventilation passage is determined depending on a viscosity of the molding material within a range from 0.001 mm to 0.15 mm, such that the molding material injected into the cavities is prevented from overflowing onto the parting surface, and a width (W) of the ventilation passage is determined depending on volumes of the cavities within a range from 0.8 mm to 18.5 mm.

4. The mold device for forming according to claim 2, wherein the ventilation passage is continuous along the parting surface, so that an outline of the ventilation passage has an open loop or closed loop shape.

5. The mold device for forming according to claim 2, wherein the gas discharge means comprises:
a gas guide groove formed in the second side of the parting surface and connected directly with the ventilation passage in a direction parallel to the ventilation passage such that the gas guide groove extends in the same direction as a longitudinal direction of the ventilation passage, the gas guide groove having a flow rate capacity equal to or greater than a flow rate capacity of the ventilation passage; and a plurality of gas discharge grooves formed in the second side of the parting surface and communicating both with the gas guide groove, in directions different from the gas guide groove, and with the outside of the parting surface, the gas discharge grooves having a flow rate capacity equal to or greater than the flow rate capacity of the ventilation passage, so that the parting surface, which has at the second side thereof an uneven surface formed by the gas discharge grooves, guides, throttles and discharges the carbonized gas drawn into the ventilation passage while maintaining the molding pressure of the cavities.

6. The mold device for forming according to claim 2, wherein the gas discharge means comprises:
a plurality of gas discharge grooves formed in the second side of the parting surface at regular intervals and communicating both with the ventilation passage, in directions different from the ventilation passage, and with the outside of the parting surface, the gas discharge grooves having a flow rate capacity equal to or greater than the flow rate capacity of the ventilation passage, so that the parting surface has at the second side thereof an uneven surface formed by the gas discharge grooves, therefore the parting surface guides discharge of the carbonized gas drawn into the ventilation passage while maintaining the molding pressure of the cavities.

7. The mold device for forming according to claim 2, wherein the gas discharge means comprises:
a gas collection groove formed in the second side of the parting surface and spaced apart from the ventilation passage by a predetermined distance such that the gas collection groove is parallel to the ventilation passage, the gas collection groove having a flow rate capacity equal to or greater than the flow rate capacity of the ventilation passage; a plurality of bridge grooves formed in the second side of the parting surface and connected both to the gas collection groove and to the ventilation groove in directions different from the gas collection groove and the ventilation groove, the bridge grooves being spaced apart from each other at regular intervals and having a flow rate capacity equal to or greater than the flow rate capacity of the ventilation passage; and a plurality of gas discharge grooves formed in the second side of the parting surface at regular intervals and communicating both with the gas collection groove, in directions different from the gas collection groove, and with the outside of the parting surface, the gas discharge grooves having a flow rate capacity equal to or greater than the flow rate capacity of the ventilation passage, so that the parting surface has at the second side thereof an uneven surface formed by the gas collection groove, the bridge grooves and the gas discharge grooves, therefore the parting surface guides and throttles the carbonized gas drawn into the ventilation passage, such that the carbonized gas is discharged outside of the parting surface, while maintaining the molding pressure of the cavities.

8. The mold device for forming according to claim 2, further comprising:
at least one partition wall, protruding from the first side of the parting surface, having the stepped portion, and partitioning the ventilation passage.

9. The mold device for forming according to claim 1, further comprising:
hardening prevention means for heating the high-temperature molding material injected into the cavities, so that the high-temperature molding material is prevented from hardening while being charged into the cavities, the hardening preventing means comprising:
a heating hole formed in at least one of the first mold and the second mold along the cavity, so that heating fluid at a high temperature circulates in the heating hole, thereby the molding material injected into the cavities maintains a molten state using radiant heat of the heating fluid.

10. The mold device for forming according to claim 3, wherein the gas discharge means comprises:
a gas guide groove formed in the second side of the parting surface and connected directly with the ventilation passage in a direction parallel to the ventilation passage such that the gas guide groove extends in the same direction as a longitudinal direction of the ventilation passage, the gas guide groove having a flow rate capacity equal to or greater than a flow rate capacity of the ventilation passage; and a plurality of gas discharge grooves formed in the second side of the parting surface and communicating both with the gas guide groove, in directions different from the gas guide groove, and with the outside of the parting surface, the gas discharge grooves having a flow rate capacity equal to or greater than the flow rate capacity of the ventilation passage, so that the parting surface, which has at the second side thereof an uneven surface formed by the gas discharge grooves, guides, throttles and discharges the carbonized gas drawn into the ventilation passage while maintaining the molding pressure of the cavities.

11. The mold device for forming according to claim 4, wherein the gas discharge means comprises:
a gas guide groove formed in the second side of the parting surface and connected directly with the ventilation passage in a direction parallel to the ventilation passage such that the gas guide groove extends in the same direction as a longitudinal direction of the ventilation passage, the gas guide groove having a flow rate capacity equal to or greater than a flow rate capacity of the ventilation passage; and a plurality of gas discharge grooves formed in the second side of the parting surface and communicating both with the gas guide groove, in directions different from the gas guide groove, and with the outside of the parting surface, the gas discharge grooves having a flow rate capacity equal to or greater than the flow rate capacity of the ventilation passage, so that the parting surface, which has at the second side thereof an uneven surface formed by the gas discharge grooves, guides, throttles and discharges the carbonized gas drawn into the ventilation passage while maintaining the molding pressure of the cavities.

12. The mold device for forming according to claim 3, wherein the gas discharge means comprises:
a plurality of gas discharge grooves formed in the second side of the parting surface at regular intervals and communicating both with the ventilation passage, in directions different from the ventilation passage, and with the outside of the parting surface, the gas discharge grooves having a flow rate capacity equal to or greater than the flow rate capacity of the ventilation passage, so that the parting surface has at the second side thereof an uneven surface formed by the gas discharge grooves, therefore the parting surface guides discharge of the carbonized gas drawn into the ventilation passage while maintaining the molding pressure of the cavities.

13. The mold device for forming according to claim 4, wherein the gas discharge means comprises:
a plurality of gas discharge grooves formed in the second side of the parting surface at regular intervals and communicating both with the ventilation passage, in directions different from the ventilation passage, and with the outside of the parting surface, the gas discharge grooves having a flow rate capacity equal to or greater than the flow rate capacity of the ventilation passage, so that the parting surface has at the second side thereof an uneven surface formed by the gas discharge grooves, therefore the parting surface guides discharge of the carbonized gas drawn into the ventilation passage while maintaining the molding pressure of the cavities.

14. The mold device for forming according to claim 3, wherein the gas discharge means comprises:
a gas collection groove formed in the second side of the parting surface and spaced apart from the ventilation passage by a predetermined distance such that the gas collection groove is parallel to the ventilation passage, the gas collection groove having a flow rate capacity equal to or greater than the flow rate capacity of the ventilation passage; a plurality of bridge grooves formed in the second side of the parting surface and connected both to the gas collection groove and to the ventilation groove in directions different from the gas collection groove and the ventilation groove, the bridge grooves being spaced apart from each other at regular intervals and having a flow rate capacity equal to or greater than the flow rate capacity of the ventilation passage; and a plurality of gas discharge grooves formed in the second side of the parting surface at regular intervals and communicating both with the gas collection groove, in directions different from the gas collection groove, and with the outside of the parting surface, the gas discharge grooves having a flow rate capacity equal to or greater than the flow rate capacity of the ventilation passage, so that the parting surface has at the second side thereof an uneven surface formed by the gas collection groove, the bridge grooves and the gas discharge grooves, therefore the parting surface guides and throttles the carbonized gas drawn into the ventilation passage, such that the carbonized gas is discharged outside of the parting surface, while maintaining the molding pressure of the cavities.

15. The mold device for forming according to claim 4, wherein the gas discharge means comprises:
a gas collection groove formed in the second side of the parting surface and spaced apart from the ventilation passage by a predetermined distance such that the gas collection groove is parallel to the ventilation passage, the gas collection groove having a flow rate capacity equal to or greater than the flow rate capacity of the ventilation passage; a plurality of bridge grooves formed in the second side of the parting surface and connected both to the gas collection groove and to the ventilation groove in directions different from the gas collection groove and the ventilation groove, the bridge grooves being spaced apart from each other at regular intervals and having a flow rate capacity equal to or greater than the flow rate capacity of the ventilation passage; and a plurality of gas discharge grooves formed in the second side of the parting surface at regular intervals and communicating both with the gas collection groove, in directions different from the gas collection groove, and with the outside of the parting surface, the gas discharge grooves having a flow rate capacity equal to or greater than the flow rate capacity of the ventilation passage, so that the parting surface has at the second side thereof an uneven surface formed by the gas collection groove, the bridge grooves and the gas discharge grooves, therefore the parting surface guides and throttles the carbonized gas drawn into the ventilation passage, such that the carbonized gas is discharged outside of the parting surface, while maintaining the molding pressure of the cavities.

16. The mold device for forming according to claim 3, further comprising:
at least one partition wall, protruding from the first side of the parting surface, having the stepped portion, and partitioning the ventilation passage.

17. The mold device for forming according to claim 4, further comprising:
at least one partition wall, protruding from the first side of the parting surface, having the stepped portion, and partitioning the ventilation passage.

18. The mold device for forming according to claim 2, further comprising:
hardening prevention means for heating the high-temperature molding material injected into the cavities, so that the high-temperature molding material is prevented from hardening while being charged into the cavities, the hardening preventing means comprising:
a heating hole formed in at least one of the first mold and the second mold along the cavity, so that heating fluid at a high temperature circulates in the heating hole, thereby the molding material injected into the cavities maintains a molten state using radiant heat of the heating fluid.

19. The mold device for forming according to claim 3, further comprising:
hardening prevention means for heating the high-temperature molding material injected into the cavities, so that the high-temperature molding material is prevented from hardening while being charged into the cavities, the hardening preventing means comprising:
a heating hole formed in at least one of the first mold and the second mold along the cavity, so that heating fluid at a high temperature circulates in the heating hole, thereby the molding material injected into the cavities maintains a molten state using radiant heat of the heating fluid.

20. The mold device for forming according to claim 4, further comprising:
hardening prevention means for heating the high-temperature molding material injected into the cavities, so that the high-temperature molding material is prevented from hardening while being charged into the cavities, the hardening preventing means comprising:
a heating hole formed in at least one of the first mold and the second mold along the cavity, so that heating fluid at a high temperature circulates in the heating hole, thereby the molding material injected into the cavities maintains a molten state using radiant heat of the heating fluid.
